(19) United States
(12) Patent Application Publication
(10) Pub. No.: US 2007/0198934 A1
(43) Pub. Date: Aug. 23, 2007

(54) Performing a Prohibited Task

(75) Inventors: Edward B. Averett, Kirkland, WA (US); John E. Brezak, Woodinville, WA (US); Jerry K. Koh, Redmond, WA (US); Michael G. Sheldon, Seattle, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/276,221

(22) Filed: Feb. 17, 2006

(51) Int. Cl. G06F 3/00

(52) U.S. Cl. 715/741

(57) ABSTRACT

System(s), method(s), and/or technique(s) (“tools”) are described that perform a prohibited task without requiring that the user request the prohibited task more than once; perform a prohibited task without requiring that a user logoff or back on; and/or perform a permitted task requested as part of a set of tasks where some of the tasks are prohibited, even if the permitted task is queued for execution after a prohibited task, and without requiring that the user elevate his or her rights.

### BACKGROUND

Generally, computer users use two types of accounts to logon to their computer. One type has nearly unlimited rights, often called an administrator account. The other has limited rights, often called a standard user account. Standard user accounts permit some tasks but prohibit others, such as deleting files installed by an administrator or another user. Administrator accounts, on the other hand, generally permit most if not all tasks.

Not surprisingly, many users logon to their computers with administrator accounts so that they may do nearly whatever they want. But there are significant risks involved in using administrator accounts. Malicious code may perform whatever tasks are permitted by the account currently in use, such as installing and deleting applications and files—potentially highly damaging tasks. This is because most malicious code performs its tasks while impersonating the current user of the computer—thus, if a user is logged on with an administrator account, the malicious code may perform dangerous tasks permitted by that account.

To reduce these risks, a user may instead logon with a standard user account. Logging on with a standard user account may reduce these risks because the standard user account may not have the right to permit malicious code to perform many dangerous tasks or administrator functions. If the standard user account does not have the right to perform a task, the computer's operating system may prohibit the malicious code from performing that task. For this reason, using a standard user account may be safer than using an administrator account.

If a user requests tasks that are not permitted by his or her standard user account, he or she may perform them by logging out of the standard user account, logging in with an administrator account, requesting the prohibited task again, logging out of the administrator account, and re-logging in with the standard user account.

### SUMMARY

System(s), method(s), and/or technique(s) (“tools”) are described that perform a prohibited task without requiring that the user request the prohibited task more than once; perform a prohibited task without requiring that a user logoff or back on; and/or perform a permitted task requested as part of a set of tasks where some of the tasks are prohibited, even if the permitted task is queued for execution after a prohibited task, and without requiring that the user elevate his or her rights.

For example, a user may request to delete five files, three of which may not be deleted because of the user's current, limited rights and two of which may. The tools may successfully delete the two files before the user elevates his or her rights, elevate the user's rights if the user selects to do so, delete the three files based on the elevated rights, and return the user to his or her limited lights.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE DRAWINGS

FIG. 1 illustrates an exemplary operating environment in which various embodiments of the tools may operate.

FIG. 2 is an exemplary process illustrating, in accordance with one embodiment, ways in which the tools enable performance of a prohibited task or a permitted task in a set of tasks having a prohibited task.

FIG. 3 shows, in accordance with one embodiment, an exemplary flow diagram with actions and/or communications between a user and elements of FIG. 1 in which the user requests to delete five files.

FIG. 4 illustrates exemplary user interfaces presented to a user as part of the flow diagram of FIG. 3.

The same numbers are used throughout the disclosure and figures to reference like components and features.

### DETAILED DESCRIPTION

Overview

The following document describes tools capable of enabling a user to perform a permitted task that is part of a set of tasks having prohibited tasks without requiring that the user first elevate his or her rights. This can save a user time and energy by not requiring that the user reselect a permitted task. The tools are also capable of performing a prohibited task without requiring that a user logoff or back on. A user instead may select to elevate his or her rights for just the prohibited task, after which the tools may perform the task and return the user's rights back to its prior, limited level. This saves a user time by not requiring that the user logoff an account that does not permit a task and then log back on to that account once the prohibited task is performed. Also, the tools are capable of performing a prohibited task without requiring that the user request the prohibited task more than once. For example, a user may request to delete a file and, once he or she elevates his or her rights, the tools can delete the file immediately. A user may not have to re-select to delete this file once his or her rights are successfully elevated.

An environment in which the tools may enable these and other actions is set forth below in a section entitled Exemplary Operating Environment. This section is followed by another describing exemplary ways in which the tools perform prohibited tasks or permitted tasks in a set of tasks having a prohibited task, entitled Performing Tasks. This overview, including these section titles and summaries, are provided for the reader's convenience and are not intended to limit the scope of the claims or the entitled sections.

Exemplary Operating Environment

Before describing the tools in detail, the following discussion of an exemplary operating environment is provided to assist the reader in understanding ways in which various inventive aspects of the tools may be employed. The environment described below constitutes but one example and is not intended to limit application of the tools to any one particular operating environment. Other environments may be used without departing from the spirit and scope of the claimed subject matter.

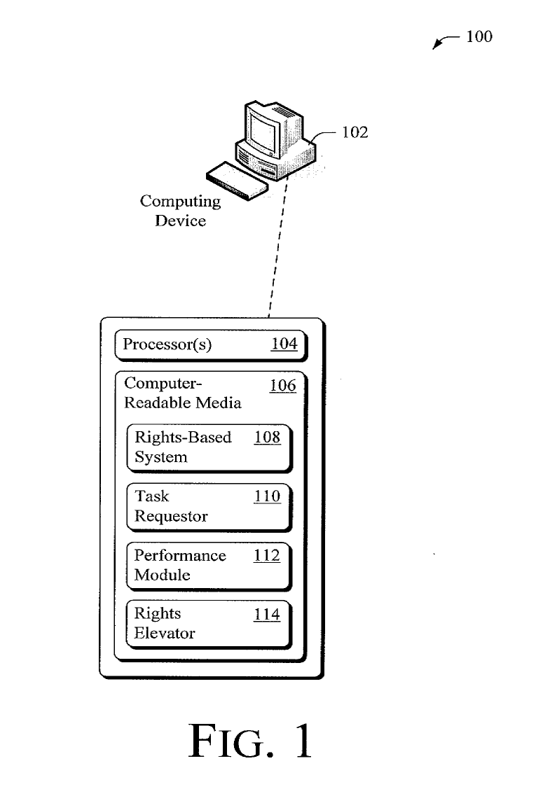

FIG. 1 illustrates one such operating environment generally at 100 comprising a computing device 102 having one or more processor(s) 104 and computer-readable media 106. The computing device is shown with a desktop computer icon but may be another type of computing device, such as a network servers smart phone, laptop, or personal digital assistant. The processors are capable of accessing and/or executing the computer-readable media. The computer-readable media comprises or has access to a rights-based system 108, a task requester 110, a performance module 112, and a rights elevator 114.

The rights-based system is capable of managing the rights contexts and requirements of one or more processes operating or capable of operating on the computing device. It may comprise an operating system, a filing system, a parental-control application, or another rights-based entity.

The task requestor is an application, applet, or module that requests tasks, such as a task prohibited based on a user's current rights (a “prohibited task”). The task requestor may be remote from or local to the computing device. The originator of the task may be task requestor 110 or an action by a user that requests, through the task requester, a prohibited task. For example, a user may request a task by entering a command into a command line or dragging-and-dropping a desktop icon from the desktop to a recycle bin.

These prohibited tasks may be any that are not permitted by the rights-based system based on the user's current rights, such as a task to delete, move, copy, or edit a file requiring higher rights (e.g., those granted by an administrator account) when the user's current rights are those granted by a limited-rights account (e.g., a standard user account). The task requestor may also request a set of tasks where one or more of the tasks are prohibited tasks and one or more are tasks that are permitted based on the user's current rights (each a “permitted task”). This set of tasks may be queued for execution in a given order, e.g., from top to bottom.

Performance module 112 may be integral with or separate from the rights-based system. The performance module may be part of or associated with: a copy engine that handles deleting and copying files in the rights-based system; an open-file engine that handles opening and editing files in the rights-based system; and/or a securities engine that handles permissions for files. The performance module is capable of determining that a task is prohibited, such as by intercepting a failure indicator (e.g., an “access denied” error) from a task being attempted and failed. The performance module is also capable of retaining prohibited tasks, such as in a queue having each failed, prohibited task associated with intercepted failure indicators.

Rights elevator 114 is capable of enabling a user to elevate his or her rights from that of a limited-rights context to that of a higher-rights context. The rights elevator may do so through a command line or graphical user interface in which credentials are received for a higher-rights account granting the higher-rights context or through selection without credentials, such as through a hot key or button on a dialog box to move from a limited-rights tier of a multi-tiered, multi-rights account to a higher-rights tier of that multi-tiered, multi-rights account.

Performing Tasks

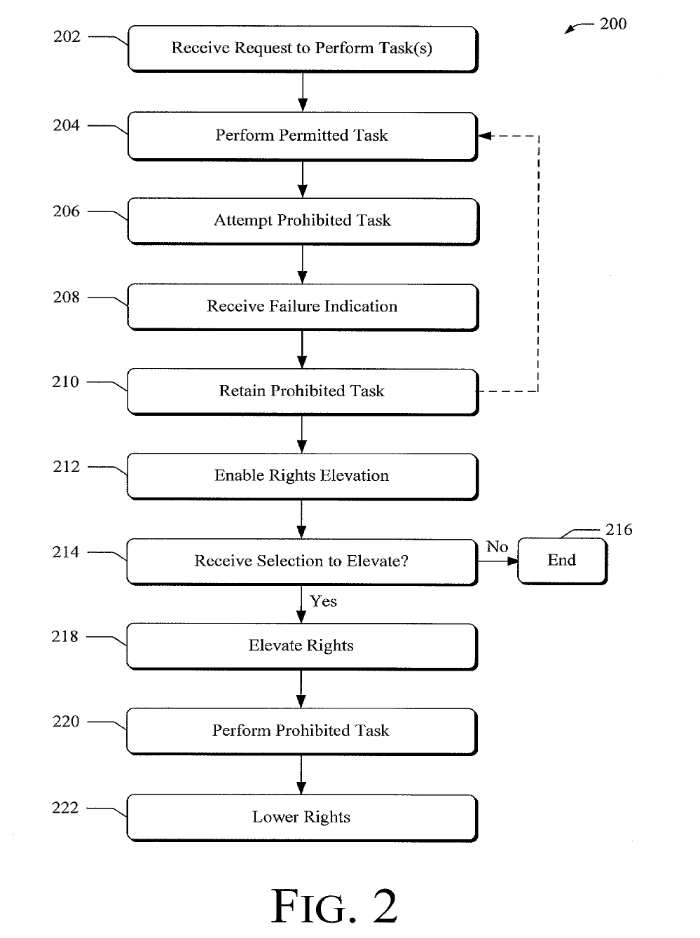

The following discussion describes exemplary ways in which the tools enable performance of a prohibited task or a permitted task in a set of tasks having a prohibited task. Process 200 of FIG. 2 illustrates, in accordance with one embodiment, some of these exemplary ways. This process is illustrated as a series of blocks representing individual operations or acts performed by elements of operating environment 100 of FIG. 1, such as performance module 112. This process may be implemented in any suitable hardware, software, firmware, or combination thereof; in the case of software and firmware, this process represents a set of operations implemented as computer-executable instructions stored in computer-readable media and executable by one or more processors.

Block 202 receives a request to perform one or more tasks at least one of which is prohibited based on the current rights context. The request may be for a single task or a set of tasks, including a set also having a task that is permitted in the current rights context. The request may be received from a user or a computer entity, such as an application or other code.

When a user logs on with a limited-rights account or a limited-rights tier of a multi-tiered, multi-rights. account the user is acting within a limited-rights context. This context may permit some tasks and prohibit others. But the user and/or the rights requestor may not know which tasks are prohibited until the rights-based system attempts them.

For example, a user may select five files on his desktop, such as with an area-select using a mouse. He may then request a task for these files with or without knowing that this task is prohibited for some of these files. Assume that he moves all five to his recycle bin to delete them. This generates a request, through task requester 110 of FIG. 1, to delete all five files. Block 202 receives this request.

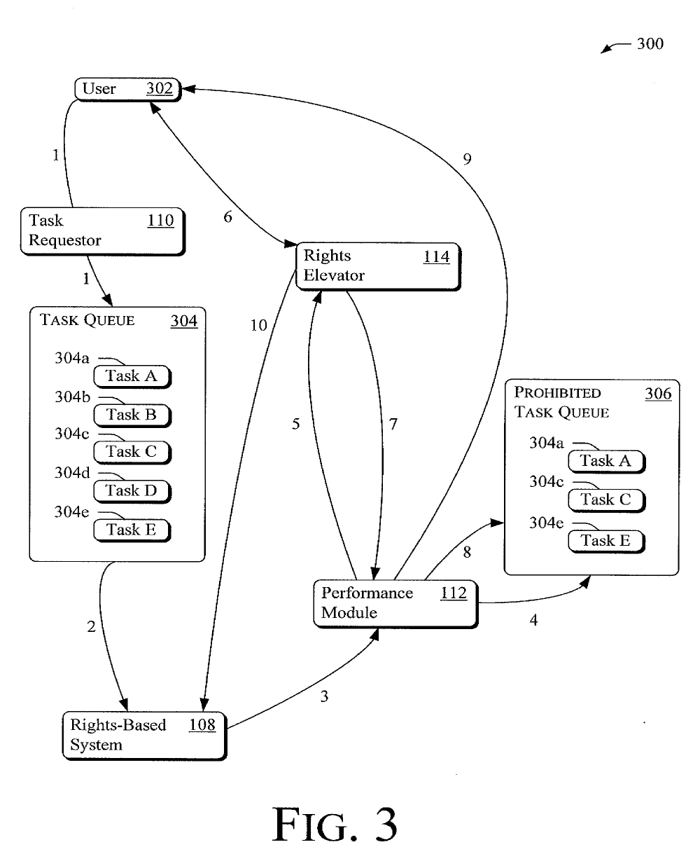

This particular example is illustrated in part in FIG. 3, which shows an exemplary flow diagram 300 in which a user 302 requests to delete five files through task requester 110. Actions by and between elements of the flow diagram are shown with arrows. Arrow 1 shows a request by the user for a set of tasks to delete five files. Here the request comprises an ordered set of tasks having two permitted tasks and three prohibited tasks. The tasks are shown in task queue 304 having five tasks 304a, 304b, 304c, 304d, and 304e. Though not necessarily yet known, tasks 304b and 304d are permitted and 304a, 304c, and 304e are not. The task requester makes this request by passing the task queue to rights-based system 108, shown at arrow 2.

Block 204 performs permitted tasks, if any. If the request is for a set of tasks, some of which are permitted, the tools may perform all of the permitted tasks regardless of the order of the permitted tasks and prohibited tasks in the ordered set of tasks. The tools may perform these permitted tasks prior to and without requiring that the user elevate his or her rights.

Assume, for example, that a user requests to delete 10,000 old files in a filing system of his server's operating system. Because this may take 10 hours, assume also that he waits until 5:30 to make the request and leaves the office at 5:35. Assume that the 35^{th} file in the queue is prohibited from being deleted. Some current systems—even if the 36^{th} through the 10,000^{th} file are permitted to be deleted—would stop and wait for a user's interaction before continuing to perform permitted tasks. When the user comes to work the next morning, instead of 9,999 files deleted only 34 have been. The tools, however, may perform all of the permitted tasks regardless of their order in the queue. With the tools, the user may come to work the next morning and see that 9,999 files have been deleted.

Block 206 attempts a prohibited task and fails. The tools may perform blocks 204 and 206 in any order, including based on the order of tasks in a set of tasks.

Block 206 may fail to perform the tasks based on the user's current rights context. The file requested to be deleted may have security permissions (e.g., those of an NTFS, New Technology File System), for example, that indicate to the rights-based system that the file may not be deleted in the current rights context.

Continuing the example of FIG. 3, the rights-based system attempts the first task (task 304a) of the task queue 304. Here the rights-based system fails task 304a and thus does not delete one of the five files selected for deletion by the user. In so doing, block 206 may generate a failure indication, such as an access denied error.

Block 208 receives a failure indication. Continuing the example shown in FIG. 3, the performance module intercepts an access denied error from the rights-based system. This is shown at arrow 3.

Block 210 retains a prohibited task. The performance module may intercept a failure indication for a failed, prohibited task and retain sufficient information about that task to later perform it, even without additional user action such as a new request for the task. Here the performance module intercepts an access denied error at arrow 3 and, based on this information or information associated with it, stores the failed task for possible later performance.

Blocks 204, 206, 208, and 210 may be repeated many times. This is illustrated with a dashed line in FIG. 2. Here task 304a is attempted and failed and retained. Task 304b is permitted, and so performed at block 204. Task 304c is also attempted and failed and retained. Task 304d is permitted and succeeds. Tasks 304e is attempted, failed, and retained. The performance module has performed two tasks of the first ordered set of tasks shown within task queue 304 and retained the other three by building a second ordered set of tasks for the prohibited tasks. These acts of retention are shown at arrow 4. A queue of prohibited tasks is shown at 306 having the retained, prohibited tasks 304a, 304c, and 304e.

Block 212 enables a user to elevate to a rights context that permits a prohibited task. Block 212 may act responsive to one or more tasks being attempted and failed for lack of rights or otherwise being informed that a task is prohibited. Note that each permitted task in a set of tasks may already be completed successfully prior to a user elevating (or not elevating) his or her rights or, in some cases, before an elevation process is even begun.

The rights-based system and/or the performance module may have an associated module for elevating rights. Here the performance module, responsive to three tasks having failed for lack of rights, causes rights elevator 114 to enable a user to elevate his or her rights context to one that is sufficient to permit at least one of the prohibited tasks. This is shown with arrow 5.

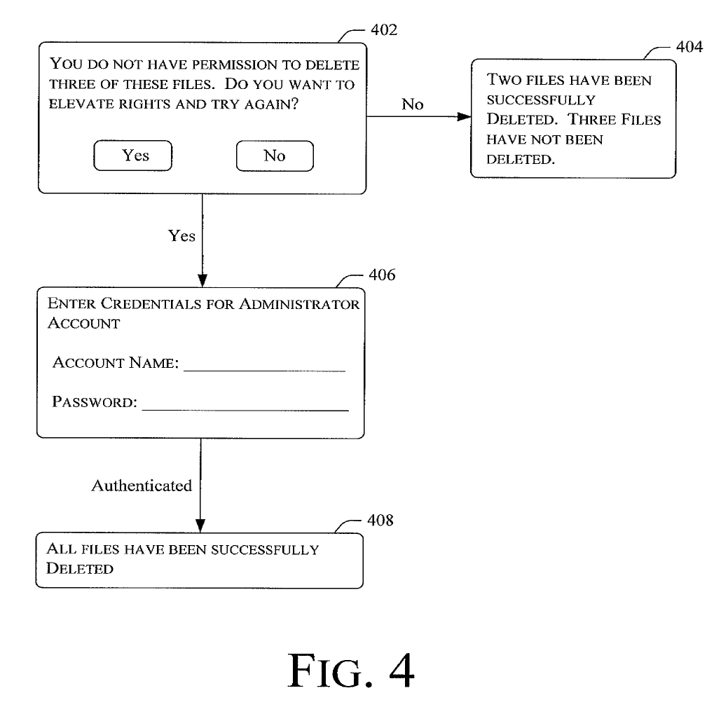

The rights elevator enables the user to select an account or tier of a multi-tiered, multi-rights account having higher rights. Exemplary communications between the user and the rights elevator are shown with arrow 6 in FIG. 3. Here the rights elevator informs the user about the user's insufficient rights context in a first user interface 402 in FIG. 4. If the user selects not to elevate rights, the rights elevator informs the user of which tasks in a set of tasks were performed, if any, and which were not. Here the rights elevator provides a second user interface 404 responsive to the user selecting not to elevate rights, which informs the user that two files were deleted and three were not.

If the user so chooses or responsive automatically to one or more failed tasks, the rights elevator provides a user interface in which the user may select to elevate rights. Here the rights elevator, using elevation user interface 406, provides data-entry fields in which a user can enter an account name and password. The rights elevator then receives the selection, which here includes name and password credentials, and authenticates the account. If it does not authenticate the account, the rights elevator may ask again or enable entry again (e.g., through user interfaces 402 and/or 406). If the account is authenticated and grants a rights context sufficient to permit the tasks, the rights elevator may inform the user that previously prohibited tasks (“now-permitted tasks”) have been successfully performed after they are performed. An example of this is shown with user interface 408 in FIG. 4.

Block 214 receives a user's selection to elevate rights or choice to not elevate rights. If the user chooses not to elevate rights the process may end, other than to inform the user about the tasks (e.g., with user interface 404 of FIG. 4). If the user selects to elevate and the account is authenticated or does not need to be authenticated, the tools proceed to block 218.

Block 218 elevates the user's rights context from a rights context having insufficient tights to permit a prohibited task to a rights context having sufficient rights to permit the prohibited task. The tools may elevate a user's rights context with or without logging a user off of a limited-rights account granting a limited-rights context and then onto a higher-rights account granting a higher-rights context. The tools may elevate a user's rights context by elevating from one tier of a multi-tiered, multi-rights account to that of a higher tier. Or the tools may maintain the user's limited-rights account while logging the user (or another user) in with a higher-rights account. In these exemplary ways, the tools may enable performance of a prohibited task without requiring a user to re-login to the rights-based system with the user's limited-rights account. Here the rights elevator elevates the user to a higher-rights context using a higher-rights account. This is communicated and shown in FIG. 3 at arrow 7.

This elevation to a higher-rights context may be constrained to just those tasks that were prohibited. Here the tools may limit the use of the higher-rights context to performance of tasks 304a, 304c, and 304e shown in FIG. 3. Once these prohibited tasks are performed, the higher-rights context may be closed. This permits an administrator, for example, to more easily help a user that does not have a higher-rights account. If the user attempts to delete a file and needs permission, the administrator can enter his or her account and know, without a having to wait for the user to logoff from the administrator account, that the administrator account will not be used for any task other than to perform those tasks that the administrator can see were prohibited (e.g., in user interface 402 of FIG. 4).

Block 220 performs a previously prohibited task. The tools may perform this task, which is now-permitted based on the elevated rights context, without further user interaction. The user's first request for the task may be sufficient. A user may not need to re-trace his or her steps or otherwise to re-request the task.

Here the performance module re-attempts each of the tasks in the prohibited task queue 306 of FIG. 3 automatically responsive to the rights being elevated and without further user interaction, shown with arrow 8. Each of the tasks 304a, 304c, and 304e are performed so long as each is now-permitted by the elevated rights context. As noted above, the elevated rights context may be constrained to only the retained, prohibited tasks (e.g., those in 306). Successful performance may be indicated to the user by the rights elevator or performance module, such as with user interface 408. Here successful performance is indicated to the user by the performance module. This is shown in FIG. 3 at arrow 9.

In some cases the elevated rights context may not allow all of the tasks to be performed. The tools may re-attempt the task and fail according to block 206 and then proceed through blocks 208 through 220. Here a third task queue may be built with the twice-attempted and failed tasks. If a user is able to elevate his or her rights context again (e.g., to an even higher-rights context), the tools may perform these tasks according to block 220.

Block 222 lowers the rights context from the higher-rights context. As mentioned above, this may be automatic based on the higher-rights context being constrained to the prohibited and retained tasks. The tools may also logoff the higher-rights account and return the user to his or her limited-rights account either by previously maintaining the user's limited-rights account or by logging the user back on with the limited-rights account. The tools may do either without interaction from the user.

The tools may also immediately lower from a higher-rights context to the user's limited-rights context responsive to the last of the now-permitted tasks being performed. Here the tools logoff the higher-rights account that granted the higher-rights context after performing task 304e in the prohibited task queue 306 of FIG. 3. This is shown performed by the rights elevator and communicated to the rights-based system at arrow 10.

The tools lower the higher-rights context thereby rendering the higher-rights context unable to permit tasks that are not permitted in the limited-rights context other than those that were previously prohibited and for which the context was elevated.

Also, by returning the user to his or her limited-rights account automatically, the user may be saved the time required to login to his or her computing device. Some login processes take considerable time, even 10 minutes, which can be disruptive.

Any and all of the blocks in process 200 may be performed without user interaction other selection to elevate rights.

In the ongoing example shown in FIG. 3, the user requested to delete five files and selected to elevate rights. These actions alone were sufficient for the tools to delete all five files; the user was not required to re-request the prohibited or permitted tasks or re-login to his or her limited-rights account.

Conclusion

The above-described systems, methods, and/or techniques enable a user to perform a prohibited task or a permitted task that is part of a set of tasks having a prohibited task. The tools enable a user to do so without necessarily requiring that the user elevate his or her rights (for permitted tasks), logoff and back on, and/or re-request previously requested tasks.

Although the systems and methods have been described in language specific to structural features and/or methodological acts, it is to be understood that the systems, methods, and techniques defined in the appended claims are not necessarily limited to the specific features or acts described. Rather, the specific features and acts are disclosed as exemplary forms of implementing the claimed systems, methods, and techniques.

1. A method implemented at least in part by a computing device comprising:
receiving a first request to perform one or more tasks in a first rights context that are not permitted in the first rights context;
elevating from the first rights context to a second rights context in which the one or more tasks are permitted; and
performing the one or more tasks in the second rights context without requiring a second request to perform the one or more tasks.

2. The method of claim 1, wherein the first request is responsive to one or more actions from a user and the act of performing performs the one or more tasks based on the first request and without requiring, after the act of elevating is performed, additional actions from the user.

3. The method of claim 1, wherein the first request further comprises a permitted task permitted in the first rights context and further comprising performing the permitted task.

4. The method of claim 3, wherein the act of performing the permitted task performs the permitted task prior to the act of elevating from the first rights context to the second rights context.

5. The method of claim 1, wherein the act of receiving receives the first request from a user logged in to a rights-based system with a first account granting the first rights context and wherein the act of elevating logs the user or another user in to the rights-based system with a second account granting the second rights context, and further comprising logging the second account off of the rights-based system responsive to the act of performing.

6. The method of claim 5, further comprising maintaining the login of the first account while the second account is logged in to the rights-based system.

7. The method of claim 1, wherein the act of receiving receives the first request from a user logged in to a rights-based system with a multi-tiered account at a first tier granting the first rights context but not the second rights context and wherein the act of elevating elevates from the first tier to a second tier, the second tier granting the second rights context.

8. The method of claim 1, wherein the act of receiving the first request intercepts a failure indication generated responsive to the one or more tasks being attempted and denied based on the first rights context not permitting the one or more tasks.

9. One or more computer-readable media having computer-readable instructions therein that, when executed by a computing device, cause the computing device to perform acts comprising:
receiving a request in a rights context to perform an ordered set of tasks having one or more permitted tasks that are permitted in the rights context and one or more prohibited tasks that are not permitted in the rights context; and
performing, without user interaction, all of the permitted tasks regardless of the order of the permitted tasks and prohibited tasks in the ordered set of tasks.

10. The media of claim 9, wherein at least one of the permitted tasks is ordered for performance prior to at least one of the prohibited tasks and at least one other of the permitted tasks is ordered for performance after at least one of the prohibited tasks.

11. The media of claim 9, further comprising performing the prohibited tasks after performing the permitted tasks and without requiring receipt of another request to perform the prohibited tasks.

12. The media of claim 9, further comprising building a second ordered set of tasks comprising the prohibited tasks, elevating from the rights context to a second rights context in which at least one of the prohibited tasks in the second ordered set of tasks is permitted to provide a now-permitted task, and performing the now-permitted task.

13. The media of claim 12, wherein the act of performing the now-permitted task is performed without requiring an act of receiving a second request from a user.

14. The media of claim 12, wherein the acts of receiving, performing all of the permitted tasks, building, elevating, and performing the now-permitted task are performed without user interaction other than receiving a selection sufficient to elevate to the second rights context.

15. The media of claim 12, further comprising building a third ordered set of tasks comprising the prohibited tasks other than the now-permitted task, elevating from the second rights context to a third rights context in which at least one of the prohibited tasks in the third ordered set is permitted, and performing this at least one prohibited task in the third ordered set.

16. The media of claim 9, wherein the ordered set of tasks comprises copying, editing, deleting, or moving files on a filing system of an operating system.

17. One or more computer-readable media having computer-readable instructions therein that, when executed by a computing device, cause the computing device to perform acts comprising:
elevating, responsive to an inability to perform a task because it is not permitted by a first user account, from the first user account to a second user account that does permit the task; and
lowering to the first user account from the second user account without requiring a user to re-login with the first user account and responsive to performing the task in the second user account.

18. The media of claim 17, wherein the act of lowering is performed without user interaction.

19. The media of claim 17, wherein the act of lowering logs off the second user account.

20. The media of claim 17, further comprising performing the task in the second user account and wherein the act of lowering is performed after the act of performing the task and before any other tasks are performed in the second user account other than the task.
